(19) United States
(12) Patent Application Publication
(10) Pub. No.: US 2014/0304686 A1
(43) Pub. Date: Oct. 9, 2014

(54) RESPONDING TO A PROBLEM DURING SOFTWARE TESTING

(71) Applicant: INTERNATIONAL BUSINESS MACHINES CORPORATION, Armonk, NY (US)

(72) Inventors: MIHOKO HASEGAWA, TOKYO (JP); HIDEAKI FUJII, FUJISAWA (JP); DAISUKE HAYASHI, TOKYO (JP); ARI MORISHITA, YOKOHAMA (JP); YOHEI NODA, YOKOHAMA (JP); HIROKAZU YASUMURO, YAMATO (JP)

(73) Assignee: INTERNATIONAL BUSINESS MACHINES CORPORATION, Armonk, NY (US)

(21) Appl. No.: 14/249,659

(22) Filed: Apr. 10, 2014

(30) Foreign Application Priority Data
Apr. 3, 2013 (JP) 2013095954

(51) Int. Cl. G06F 11/36

(52) U.S. Cl. CPC G06F 11/3664
USPC 717/125

(57) ABSTRACT

An apparatus executes and tests software. The apparatus comprises: an execution hardware unit that executes software to be tested; an interface screen control hardware unit that causes a display device to display an interface screen by the software to be tested and receives a user's input operation using the interface screen; and a problem report management hardware unit that manages information on a problem that has occurred during a test of the software, wherein the problem report management hardware unit includes: a selection operation receiving hardware unit that receives a selection of a component part of the interface screen; an input receiving hardware unit that receives a user's input of information; and a report generating hardware unit that generates report information on the component part, based on information on the component part related to the selection received.

### BACKGROUND

The present invention relates to a tool for testing software and to an apparatus, method, and program for managing information on a problem detected in a test.

In software development, various tests of functions provided by software, user interfaces, and the like are performed. If a problem is detected in a test, a report of the detected problem (hereinafter, referred to as “problem report”) is released to a person in charge of software development (a programmer or the like) and software modification or the like is performed.

For example, with respect to the conventional technology disclosed in the prior art, it is disclosed that an error report mail describing detailed information on an error and a source file identifier is generated and transmitted to an e-mail address of a source administrator in the case of occurrence of the error in evaluation processing of software.

### SUMMARY

In one embodiment of the present invention, an apparatus executes and tests software. The apparatus comprises: an execution hardware unit that executes software to be tested; an interface screen control hardware unit that causes a display device to display an interface screen by the software to be tested and receives a user's input operation using the interface screen; and a problem report management hardware unit that manages information on a problem that has occurred during a test of the software, wherein the problem report management unit includes: a selection operation receiving hardware unit that receives a selection of a component part of the interface screen; an input receiving hardware unit that receives a user's input of information; a report generating hardware unit that generates report information on the component part, based on information on the component part related to the selection received by the selection operation receiving unit and information received by the input receiving unit; and a notification display hardware unit that performs notification display to give notice that there is a component part for which report information has been generated, in response to the component part related to the selection received by the selection operation receiving unit including the component part for which the report information has been generated by the report generating unit.

In one embodiment of the present invention, an apparatus executes and tests software. The apparatus comprises: an execution hardware unit that executes software to be tested; an interface screen control hardware unit that causes a display device to display an interface screen by the software to be tested and receives a user's input operation using the interface screen; and a problem report management hardware unit that manages information on a problem that has occurred during a test of the software, wherein the problem report management hardware unit includes: a selection operation receiving hardware unit that receives a selection of a component part of the interface screen; an input receiving hardware unit that receives a user's input of information; and a report generating hardware unit that generates report information on the component part, based on information on the component part related to the selection received by the selection operation receiving hardware unit and information received by the input receiving hardware unit.

In one embodiment of the present invention, an apparatus executes and tests software. The apparatus comprises: an execution hardware unit that executes software to be tested; an interface screen control hardware unit that causes a display device to display an interface screen by the software to be tested and receives a user's input operation using the interface screen; and a problem report management hardware unit that manages information on a problem that has occurred during a test of the software, wherein the problem report management hardware unit includes: a selection operation receiving hardware unit that receives a selection of a component part of the interface screen; an acquisition hardware unit that acquires report information generated with respect to the component part of the interface screen; and a notification display hardware unit that performs notification display to give notice to a selection part, which is the component part related to the selection received by the selection operation receiving hardware unit, that there is a component part for which report information has been generated, in a case in which the selection part includes the component part for which the report information has been generated.

### BRIEF DESCRIPTION OF THE SEVERAL VIEWS OF THE DRAWINGS

FIG. 1 is a diagram illustrating an example of the functional configuration of a computer system to which the present embodiment is applied;

FIG. 2 is a diagram illustrating a functional configuration example of a problem report management unit of a display control unit illustrated in FIG. 1;

FIG. 3 is a diagram illustrating an example of a GUI screen;

FIG. 4 is a diagram illustrating an example of target selection and menu display;

FIG. 5 is a diagram illustrating an example of registered contents of an administrative DB;

FIG. 6 is a diagram illustrating another example of target selection and menu display;

FIG. 7 is a diagram illustrating a state where the notification display is performed for a registered part within the area of the target illustrated in FIG. 6;

FIG. 8 is a diagram illustrating an example of a display of a problem report in the embodiment;

FIG. 9 is a diagram illustrating a state where the problem reports are listed in the embodiment;

FIG. 10 is a flowchart illustrating a flow of processing by the problem report management unit of the embodiment; and

FIG. 11 is a diagram illustrating a hardware configuration example preferable for constituting a computer system according to the embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The embodiment of the present invention will be described in detail hereinafter with reference to accompanying drawings.

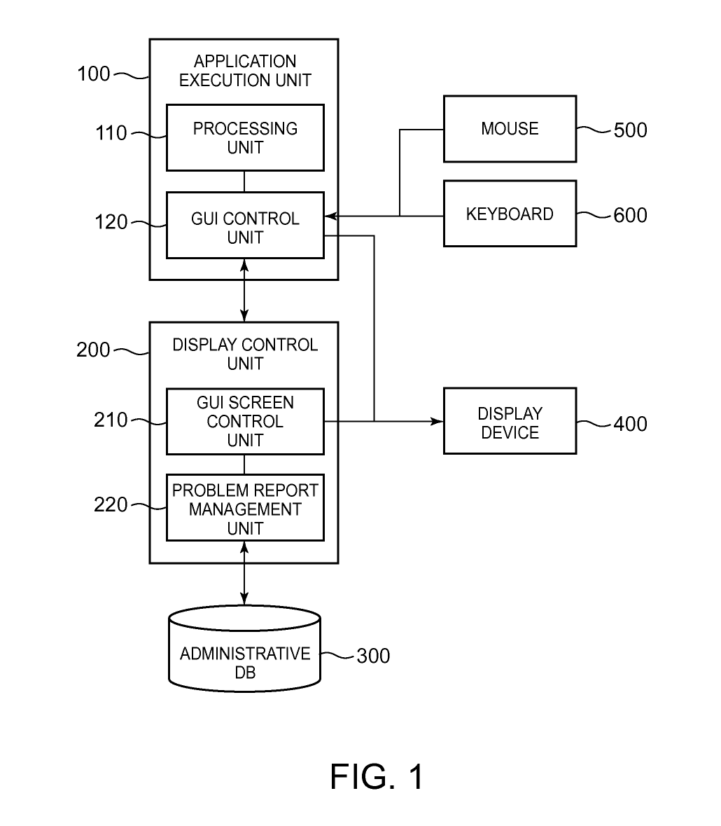

FIG. 1 is a diagram illustrating an example of the functional configuration of a computer system to which the present embodiment is applied. The system illustrated in FIG. 1 includes an application execution unit 100 which executes software (an application program, hereinafter, referred to as “application”) to be tested and a display control unit 200 which causes a display device to display a GUI screen of the software. Furthermore, the system includes an administrative database (DB) 300 which retains data of a problem report generated in the embodiment. In addition, as illustrated in FIG. 1, this system is connected to a display device 400 for displaying a GUI screen and a mouse 500 and a keyboard 600 for use in performing an input.

The application execution unit 100 executes an application to be tested. The application execution is performed in the same manner as for a case where a user of the application actually uses the application. As illustrated in FIG. 1, the application execution unit 100 includes a processing unit 110 and a GUI control unit 120.

The processing unit 110 executes various types of data processing prepared on the basis of an intended use of the application. The types of data processing performed by the processing unit 110 may be any of various computations, data retrieval and processing, or any other existing processes and a combination thereof, and the types of data processing are not particularly limited in this embodiment.

The GUI control unit 120 generates a GUI screen for use in providing a user with information. Moreover, the GUI control unit 120 receives an input by a user's operation on the GUI screen. The information provided to the user on the GUI screen includes an execution result of processing by the processing unit 110. Further, in this embodiment, it is assumed that the GUI screen is generated by using HTML or the like and is generated as a screen displayed by a Web browser (a screen displayed on the Web).

The display control unit 200 causes the display device 400 to display the GUI screen generated by the GUI control unit 120 of the application execution unit 100. Since the GUI screen is generated as a screen displayed on the Web in this embodiment as described above, the display control unit 200 is able to be implemented by the Web browser. As illustrated in FIG. 1, the display control unit 200 includes a GUI screen control unit 210 and a problem report management unit 220.

The GUI screen control unit 210 causes the display device 400 to display a GUI screen and receives an operation performed on the displayed GUI screen. Specifically, the GUI screen control unit 210 causes a transition to a linked page by an operation using a pointing device such as a mouse or receives a text input to an input field on the GUI screen. In this embodiment, these processes are implemented by basic functions of a general Web browser.

The problem report management unit 220 receives an input of a problem report of a problem which has occurred after the execution of the application and manages the problem report which has been input. In addition, the problem report management unit 220 receives a request for viewing a problem report and causes the display device 400 to display a corresponding problem report. In this embodiment, the function of the problem report management unit 220 is provided as, for example, an additional function (add-on or the like) of a Web browser which implements the display control unit 200. The details of the function of the problem report management unit 220 will be described later.

The administrative DB 300 stores problem reports received by the problem report management unit 220. The administrative DB 300 is implemented by using storage means such as a memory and a magnetic disk storage unit included in the computer system of this embodiment.

The display device 400 is implemented by a display device such as a liquid crystal display and displays a GUI screen by the control of the GUI screen control unit 210. The mouse 500 and the keyboard 600 are input devices which are used by a user to perform input operations. The user refers to the GUI screen displayed on the display device 400 and inputs various commands and texts by manipulating the mouse 500 and the keyboard 600. Alternatively, an appropriate pointing device such as a trackball or a tablet may be used instead of the mouse 500.

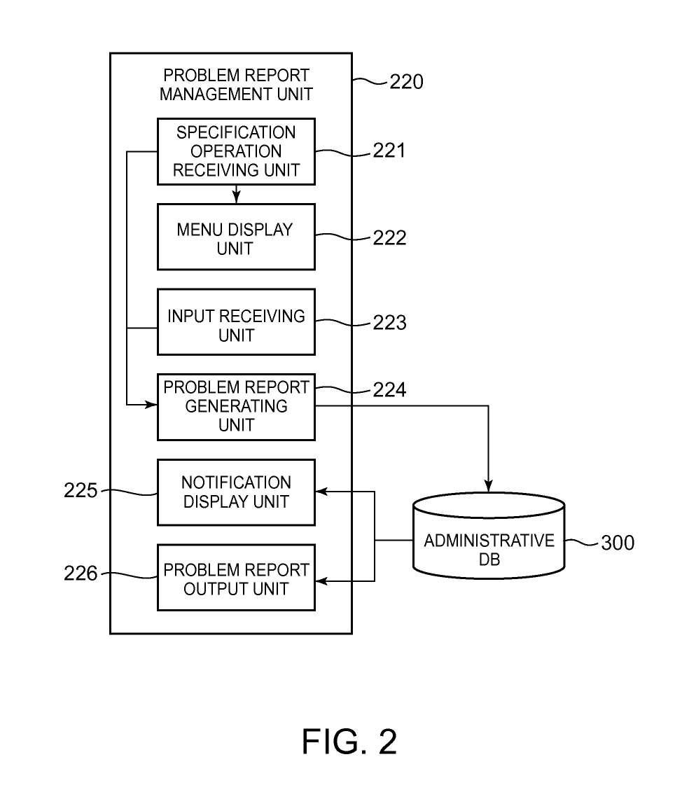

FIG. 2 is a diagram illustrating a functional configuration example of the problem report management unit 220 of the display control unit 200. As illustrated in FIG. 2, the problem report management unit 220 includes a selection operation receiving unit 221, a menu display unit 222, an input receiving unit 223, a problem report generating unit 224, a notification display unit 225, and a problem report output unit 226.

The selection operation receiving unit 221 receives an operation of identifying an object (hereinafter, referred to as “target”) of the registration and viewing of a problem report, which is a component part of the GUI screen. Specifically, for example, when a drag operation of the mouse 500 is performed on the GUI screen, the selection operation receiving unit 221 is able to receive a rectangular area having a straight line connecting the start point with the end point as a diagonal line, as a target. Moreover, when a mouse pointer is placed in the position of an object (an icon, an input form, a dialog box, a section [pane] within a window, or the like) constituting the GUI screen or when an operation for displaying a menu described later is performed in the state, the selection operation receiving unit 221 may receive the object in the position where the mouse pointer is placed as a target. Additionally, the target may be selected on the basis of various operations capable of selecting a particular range or an object on the GUI screen. Moreover, the selection operation receiving unit 221 may perform display control such as, for example, enclosing an object selected as a target by a particular frame border. This enables the user to easily recognize the object or range selected as a target.

The menu display unit 222 displays a menu for use in calling a function of the problem report management unit 220 in response to a user's operation. It is assumed that functions which can be called on the menu include at least a function of registering a problem report and a function of viewing an already-registered problem report. Specifically, for example, in response to a selection of a target on the GUI screen and then an operation such as clicking the right button of the mouse 500, the GUI screen displays a menu for use in selecting one of the function of registering a problem report and the function of viewing a problem report already registered regarding the selected target.

The input receiving unit 223 receives a user's input of information in the case of selection of the function of registering a problem report on the menu displayed by the menu display unit 222. Specifically, for example, the input receiving unit 223 causes the display device 400 to display a window, a text box, or the like other than the GUI screen and receives an input of text data on the title of the problem report or the content of the problem.

The problem report generating unit 224 generates a problem report (report information) on the basis of the information on the target of the problem report received by the selection operation receiving unit 221 and the user's input information received by the input receiving unit 223. Moreover, the problem report generating unit 224 acquires image data of the GUI screen (screen capturing) at the selection of the function of registering the problem report on the menu displayed by the menu display unit 222 and stores the image data in the administrative DB 300. Furthermore, the problem report generating unit 224 puts the information on the acquired image data (captured image) in the problem report. The generated problem report is stored in the administrative DB 300. A specific configuration of the problem report stored in the administrative DB 300 is described later.

In the case where the function of viewing an already-registered problem report is selected on the menu displayed by the menu display unit 222 and if the problem report has already been registered regarding the target specified on the GUI screen, the notification display unit 225 displays the notification of the registration (hereinafter, referred to as “notification display”). In the case where the rectangular area identified by a drag operation of the mouse 500 is selected as a target and if a part which has been selected as a target in past years and for which a problem report has been registered (the part is an area, an object, or the like and hereinafter referred to as “registered part”) exists within the area selected as the target, the notification display unit 225 performs notification display of the registered part. If a plurality of registered parts is included in the area specified as a target, the notification display unit 225 performs notification display for each of the registered parts within the selected area. Moreover, in the case where a target is selected in units of an object constituting the GUI screen or the like cases, the object selected as a target coincides with a registered part in some cases. In this case, the notification display unit 225 performs notification display with the selected target as a registered part.

The notification display may be of any form as long as a user can be notified of a fact that the problem report has already been registered (a registered part exists) regarding the selected target, and various notification modes may be employed. For example, a particular icon or badge (icon badge) set as a notification display may be displayed in the vicinity of the registered part or the registered part may be highlighted by means of changing a display color or the like.

In the case where a plurality of problem reports is registered regarding an individual registered part, the notification display unit 225 may perform the notification display in such a way that the user is able to recognize the fact. For example, in the case where particular icons are displayed as the notification display, the particular icons are displayed in a row by the number of registered problem reports.

In the case of the execution of the operation of selecting the registered part for which notification display has been performed by the notification display unit 225, the problem report output unit 226 causes the display device 400 to display the content of the problem report registered regarding the selected registered part. Specifically, the problem report output unit 226 identifies the problem report stored in the administrative DB 300 regarding the registered part on the basis of the information (position information or the like: the details are described later) on the selected registered part and reads and displays the problem report from the administrative DB 300. The registered part is selected by an operation such as, for example, placing the mouse pointer on the part for which notification display is performed and then clicking a mouse button (mouse click). Moreover, the apparatus may be adapted to accept an operation of selecting a plurality of registered parts, so that the contents of the problem reports are displayed for the plurality of registered parts which have been selected, respectively.

As for the display mode of a problem report, various existing approaches are applicable to the display. For example, it is possible to display a balloon in the vicinity of the target to display the content of a problem in the problem report read from the administrative DB 300. Moreover, the problem report read from the administrative DB 300 may be displayed after displaying a section (pane) for displaying a problem report in a part of the GUI screen or displaying a window other than the GUI screen.

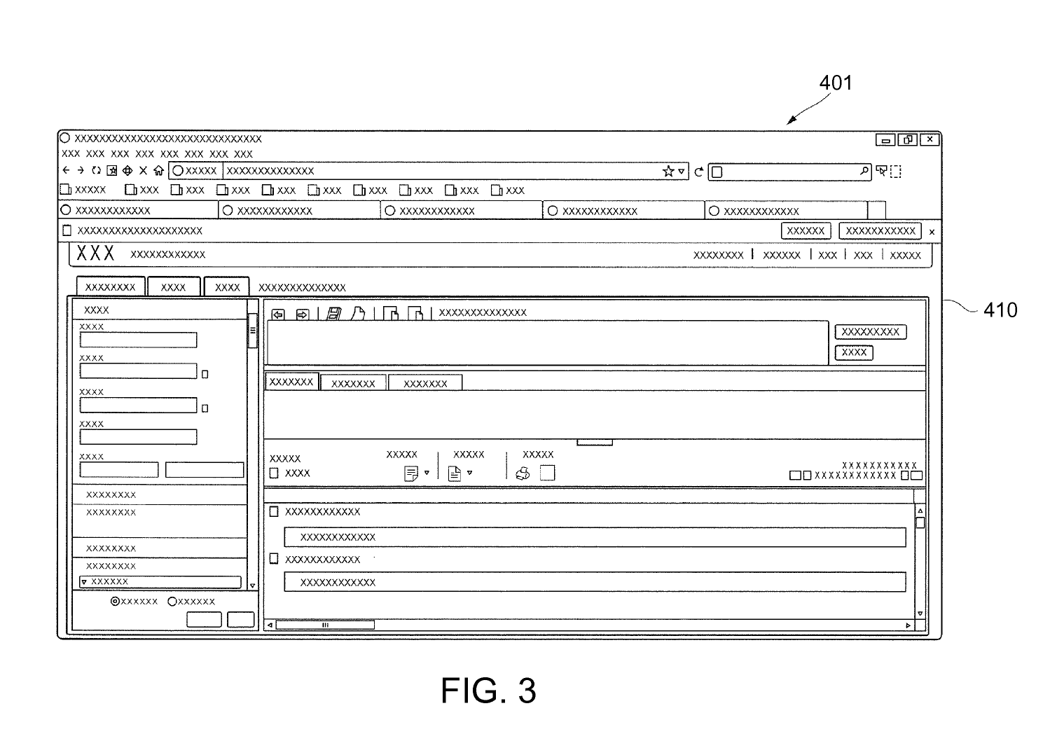

FIG. 3 is a diagram illustrating an example of a GUI screen. A GUI screen 410 illustrated in FIG. 3 is displayed within a window 401 displayed by the display device 400. Moreover, as illustrated in FIG. 3, various objects such as an icon, an input form, a checkbox, a tag, a scroll bar, and the like as components constituting the screen are displayed on the GUI screen 410.

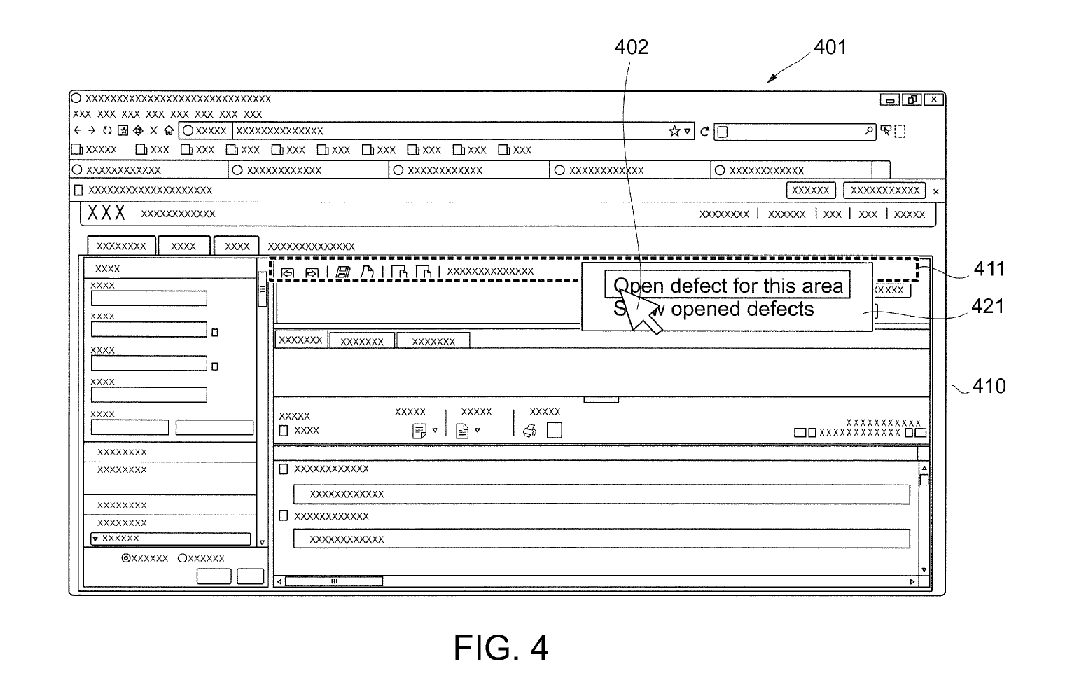

FIG. 4 is a diagram illustrating an example of target selection and menu display. In the example illustrated in FIG. 4, a target 411 is specified on the GUI screen 410 illustrated in FIG. 3. In the target 411, a frame enclosed by a thick dashed line is displayed, so that the user can recognize the range of the target 411. Moreover, on the GUI screen 410 illustrated in FIG. 4, the menu display unit 222 displays a menu 421 regarding the target 411 in response to a user's operation. In the example illustrated in FIG. 4, a mouse pointer 402 is placed in the position of “problem report registration” (described as “Open defect for this area” in FIG. 4) among the items displayed on the menu 421 to select the function.

Upon selection of the “problem report registration” function after the operation of a mouse click or the like in the state illustrated in FIG. 4, the input receiving unit 223 receives a text input. Immediately after the user inputs the title of the problem report and the content of the problem, the problem report generating unit 224 generates a problem report and then the problem report is stored in the administrative DB 300.

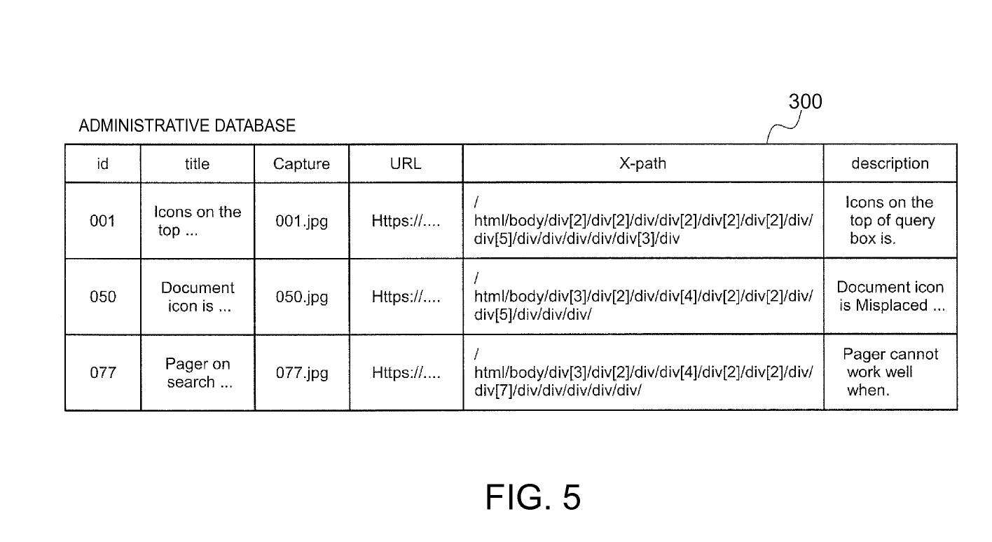

FIG. 5 is a diagram illustrating an example of registered content of the administrative DB 300. In the example illustrated in FIG. 5, the administrative DB 300 stores information on the following items: identification information (id), a title (title), a file name of a captured image (Capture), a site where the GUI screen 410 which is an object of the problem report (where a problem has occurred) exists (URL), the position of a target specified on the GUI screen 410 (X-path), and the content of the problem (description) regarding each problem report. Among these pieces of information, the identification information (id) is automatically generated by the problem report generating unit 224. The file name of the captured image (Capture) and the site of the GUI screen 410 (URL) are automatically generated by the problem report generating unit 224 when the problem report generating unit 224 acquires the captured image. The position of the target (X-path) is acquired by the problem report generating unit 224 from the GUI screen control unit 210 which controls the display of the GUI screen 410. The title (title) and the content of the problem (description) are acquired after the input receiving unit 223 receives a user's input operation. In the example illustrated in FIG. 5, the target position on the GUI screen is represented by using the X-path which is a syntax indicating a particular part or element of an XML document. The information on the target position, however, only needs to be information by which the position on the GUI screen can be identified, and not limited to the description using an X-path.

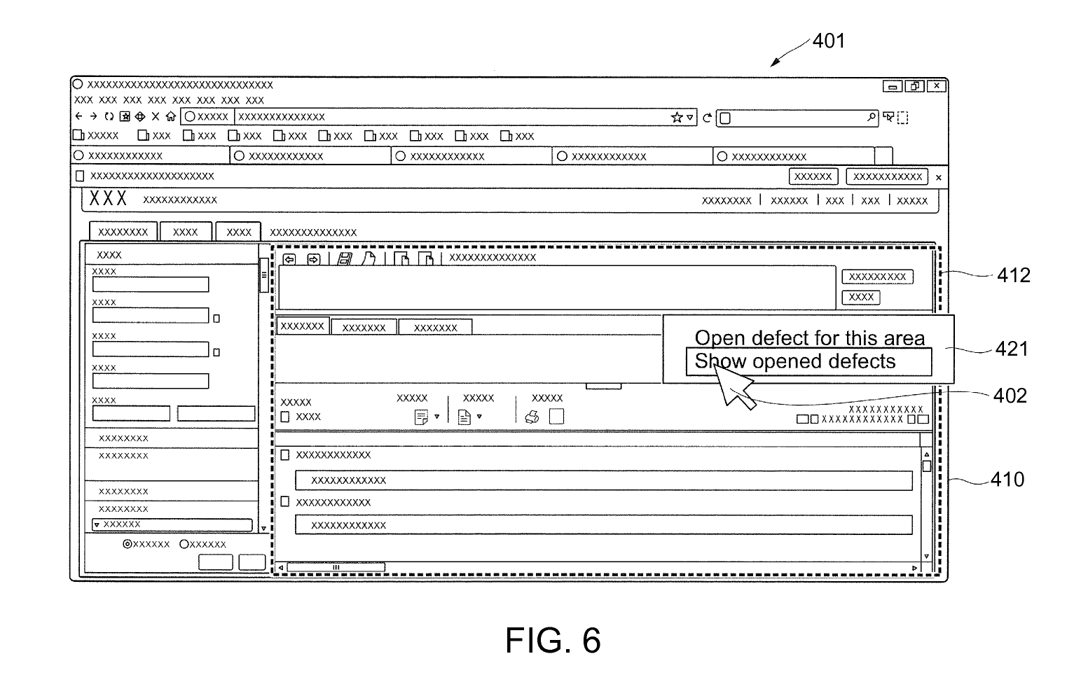

FIG. 6 is a diagram illustrating another example of target selection and menu display. In the example illustrated in FIG. 6, a target 412 different from the example illustrated in FIG. 4 is selected on the GUI screen 410 illustrated in FIG. 3 and a menu 421 is displayed regarding the target 412. Moreover, in the example illustrated in FIG. 6, the mouse pointer 402 is placed in the position of “problem report viewing” (stated as “Show opened defects” in FIG. 6) among the items displayed in the menu 421, thereby illustrating a state where this function is selected.

After the “problem report viewing” function is selected by performing an operation such as a mouse click in the state illustrated in FIG. 6, the notification display unit 225 performs the notification display for a registered part (the part for which a problem report has been registered) included in the area of the target 412. If a plurality of registered parts exists in the area of the target 412, the notification display is performed for each registered part individually.

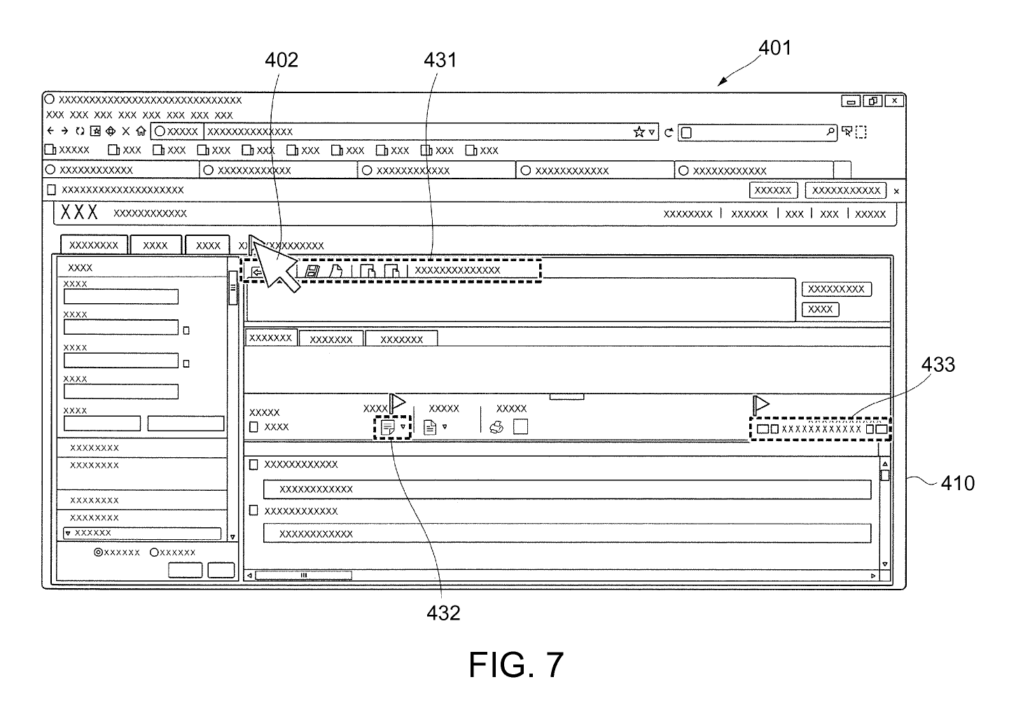

FIG. 7 is a diagram illustrating a state where the notification display has been performed for the registered part within the area of the target 412 illustrated in FIG. 6. Referring to FIG. 7, three registered parts 431, 432, and 433 exist within the area of the target 412 illustrated in FIG. 6. In the example illustrated in FIG. 7, the frame display indicated by a thick dashed line is changed from the display representing the target 412 to the displays representing the registered parts 431, 432, and 433. The illustrated display mode is merely illustrative and the frames of the registered parts 431, 432, and 433 may be displayed with the frame indicating the target 412 also displayed or frames in a mode different from the mode of the frame indicating the target 412 may be displayed for the registered parts 431, 432, and 433.

Upon the selection operation of the registered parts 431, 432, and 433 in the state illustrated in FIG. 7, the problem report output unit 226 displays the contents of the problem reports of the selected registered parts 431, 432, and 433. In the example illustrated in FIG. 7, the mouse pointer 402 is placed in the position of the registered part 431, thereby illustrating the state where the registered part 431 is selected.

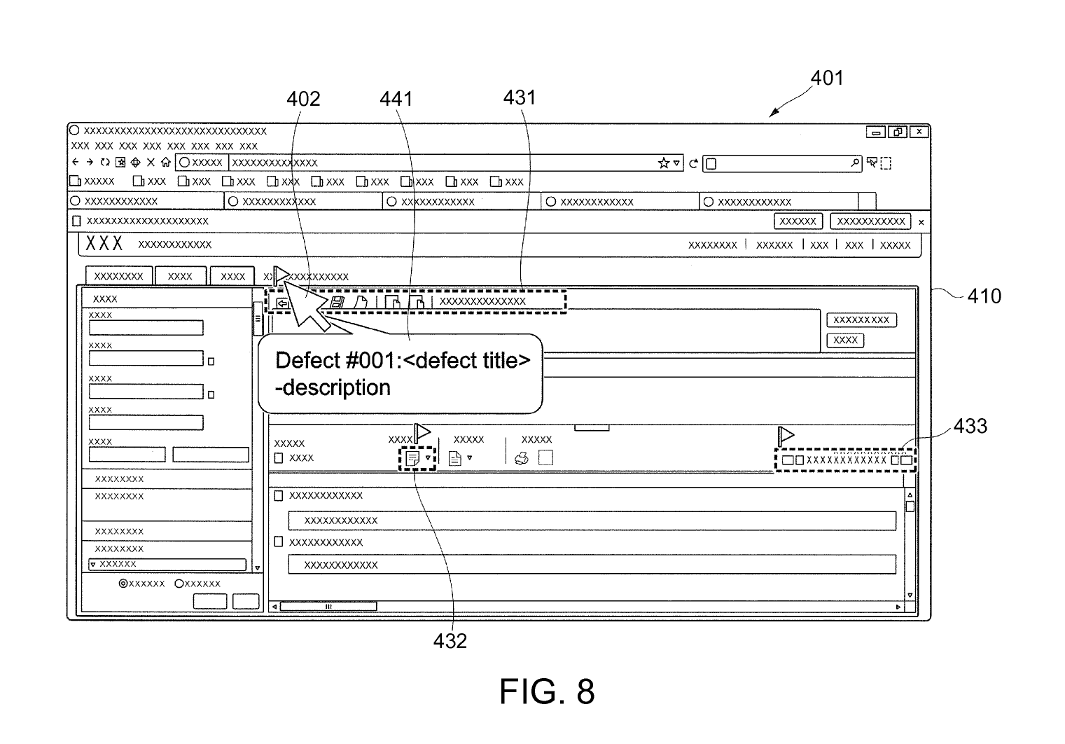

FIG. 8 is a diagram illustrating an example of a display of a problem report. In the example illustrated in FIG. 8, a balloon 441 is displayed in the vicinity of the selected registered part 431. Further, in the inside of the balloon 441, there are displayed identification information in the problem report of the registered part 431, a title (defect title), and the content of the problem. Although not illustrated in FIG. 8, the problem report display may include link information to the destination in which the captured image is stored. This enables the captured image to be rapidly displayed on the basis of the above link information when a user viewing the problem report wants to check the state of the GUI screen in the case of an occurrence of a problem.

The method of selecting the registered part when the user views the problem report is not limited to the method illustrated in FIG. 8, as long as the user is able to select a desired registered part in order to identify the problem report which the user wants to view. As another method, for example, the registered parts for which notification display has been made (the registered parts 431, 432, and 433 in the example illustrated in FIG. 7) may be listed to allow a user to select a desired registered part on the list. The listing is performed, for example, by selecting a function of displaying a list of the registered parts from a menu box of the window 401 for displaying the GUI screen. Immediately after this function is selected, the problem report output unit 226 of the problem report management unit 220 reads out the problem reports of the registered parts for which the notification display has been made from the administrative DB 300 under the control of the GUI screen control unit 210 of the display control unit 200 and lists, for example, identification information on the display device 400.

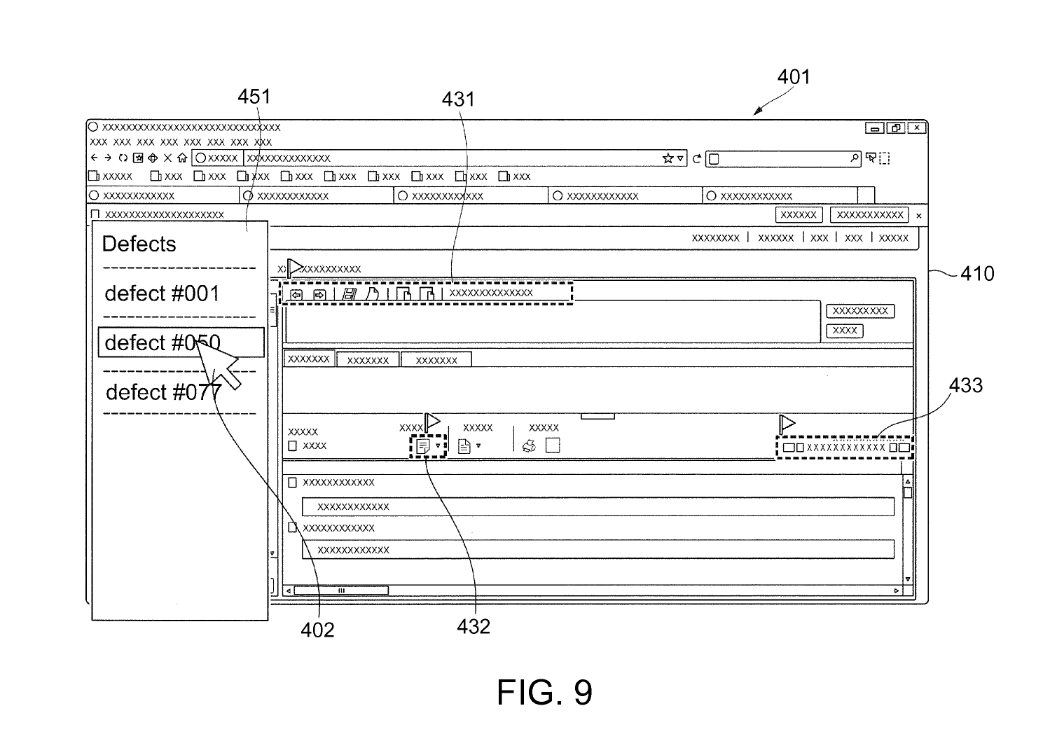

FIG. 9 is a diagram illustrating a state where the problem reports are listed. In the example illustrated in FIG. 9, a list 451 of the problem reports of the registered parts 431, 432, and 433 displayed on the GUI screen 410 is superimposed on the window 401 on the display. The list 451 lists the identification information of the registered part 431 (defect #001), the identification information of the registered part 432 (defect #050), and the identification information of the registered part 433 (defect #077). If one of the registered parts 431, 432, and 433 is selected on the list 451, the problem report output unit 226 displays the content of the problem report of the selected registered part 431, 432, or 433. In the example illustrated in FIG. 9, the mouse pointer 402 is placed in the position of the identification information (defect #050) of the registered part 432 in the list 451, thereby illustrating the state where the registered part 432 is selected.

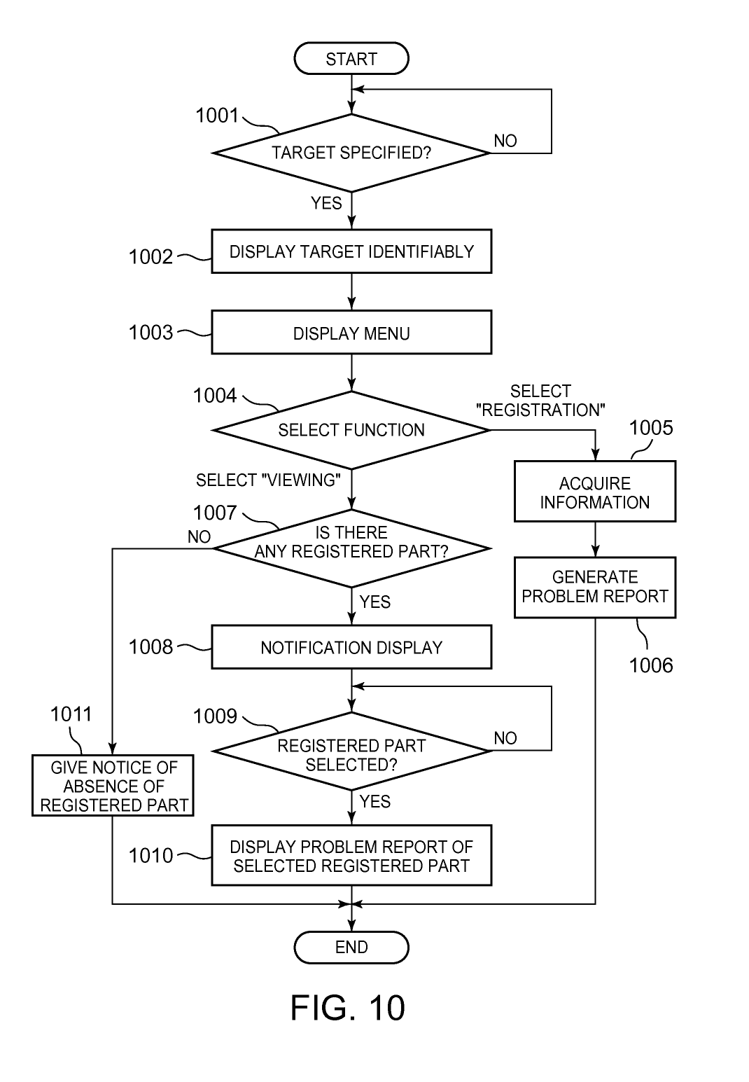

FIG. 10 is a flowchart illustrating the flow of the processing of the problem report management unit 220 according to the present embodiment. If a target is selected by a user's operation on the GUI screen 410 displayed on the display device 400 (step 1001), the selection operation receiving unit 221 receives this operation to control the display so that the selected target is identifiable (step 1002). Subsequently, the menu display unit 222 displays a menu in response to a user's operation (step 1003) and awaits a user to select a function.

If the “problem report registration” function is selected by a user's operation (step 1004), the input receiving unit 223 receives a user's input of a text and the problem report generating unit 224 acquires information on the captured image of the GUI screen or a target (step 1005). Thereafter, the problem report generating unit 224 generates a problem report on the basis of the acquired information and stores the problem report into the administrative DB 300 (step 1006).

On the other hand, if the “problem report viewing” function is selected by a user's operation from the menu displayed in step 1003 (step 1004), the notification display unit 225 determines whether the registered part exists within the area of the selected target (step 1007). If the registered part exists, the notification display unit 225 performs notification display for the detected registered part (step 1008).

Subsequently, if the user performs an operation of selecting the registered part (step 1009), the problem report output unit 226 reads out the problem report of the selected registered part from the administrative DB 300 and displays the problem report (step 1010). Unless the registered part exists within the area of the selected target, the notification display unit 225 performs a notification display indicating that the registered part does not exist (step 1011).

Alternatively, unless the registered part exists, the display of the “problem report viewing” function may be prevented on the menu display in step 1003. In such a case, step 1007 is unnecessary.

As described herein, according to the embodiment, a place where the problem occurs can be pointed out by using a graphical user interface on the GUI screen displayed on the display device 400 in a software test and a problem report can be registered and viewed. Therefore, a user who wants to register a problem report (a tester or the like) is able to directly point out the place where the problem occurs on the GUI screen, thereby facilitating the generation of the problem report. Moreover, for a user who wants to view a problem report (a person in charge of software development or the like), it is easy to intuitively grasp how many problems are reported in which part of the software since the place for which the problem report is generated is displayed on the GUI screen. Furthermore, the problem report generating unit 224 acquires the captured image of the GUI screen when the problem report is registered in this embodiment, and therefore there is no need for a user to perform the operation of acquiring and storing the image data of the GUI screen every time a problem report is generated, thereby enabling a remarkable reduction in labor hours required for the generation of the problem report.

In one embodiment, the notification display unit 225 performs the notification display of the registered part in response to a selection of the “problem report viewing” function after the selection of the target on the GUI screen. In contrast, at the instant of the selection of the target, the notification display unit 225 may search for the registered part included in the area of the specified target and perform the notification display. If a new problem report is registered for the selected target, a menu may be displayed for the target for which the notification display of the registered part has been performed, so that the “problem report registration” function is selected.

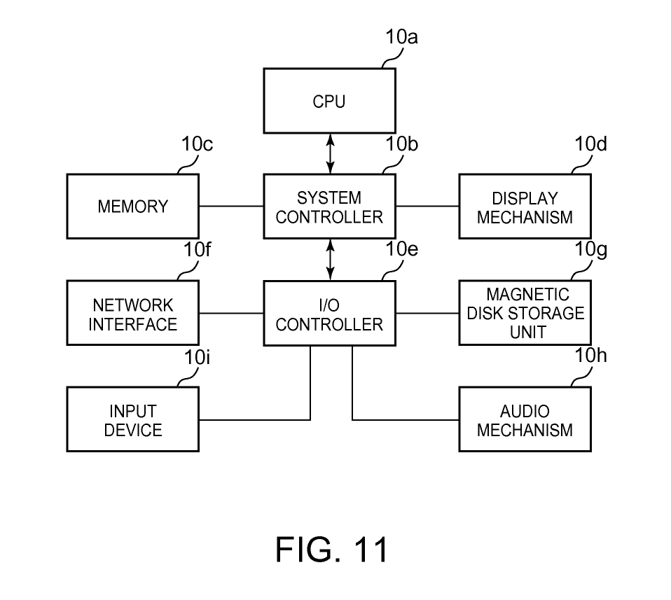

FIG. 11 is a diagram illustrating a hardware configuration example preferable for constituting a computer system according to the present embodiment. The computer illustrated in FIG. 11 includes a central processing unit (CPU) 10a which is computing means and a memory 10c which is main storage means. Moreover, the computer includes a magnetic disk storage unit (HDD: hard disk drive) 10g, a network interface 10f, a display mechanism 10d, an audio mechanism 10h, an input device 10i such as a keyboard or a mouse, and the like as external devices.

In the configuration example illustrated in FIG. 11, the memory 10c and the display mechanism 10d are connected to the CPU 10a via a system controller 10b. Further, the network interface 10f, the magnetic disk storage unit 10g, the audio mechanism 10h, and the input device 10i are connected to the system controller 10b via an I/O controller 10e. The components are connected via various buses such as a system bus and an I/O bus.

FIG. 11 merely illustrates the hardware configuration of a computer preferable for the present embodiment is to be applied. The present embodiment is widely applicable to a system which determines whether a particular event has occurred while managing the resources of a system to be managed and outputs management information based on a result of the determination, but the present embodiment is not implemented only in the illustrated configuration.

In FIG. 11, the OS and application software programs are stored in the magnetic disk storage unit 10g. Further, these programs are read into the memory 10c and executed by the CPU 10a, by which the respective functions of the application execution unit 100 and the display control unit 200 in the present embodiment are implemented. Moreover, the administrative DB 300 is implemented by storage means such as the memory 10c or the magnetic disk storage unit 10g. Further, the display device 400 is implemented by the display mechanism 10d. The mouse 500 and the keyboard 600 correspond to input devices 10i.

Although the GUI screen has been described as a screen displayed on the web in this embodiment, the GUI screen is not limited thereto. Moreover, although the problem report is registered in association with the GUI screen in the present embodiment, a problem treated in the problem report is not limited to a problem in the GUI. For example, even in the case of a problem related to the software operation, the problem report can be registered with an appropriate part on the related GUI screen as an index. In addition, the aforementioned embodiment, in which various changes or improvements are made, is also covered by the technical scope of the present invention.

The present invention presents a new and novel solution to one or more of the following problems and/or scenarios.

A problem report associated with a software test is generated generally by describing a place where a problem occurs and a content of the problem in written form. Moreover, in the case of a problem report of a graphical user interface (GUI), image data on a display screen by GUI (hereinafter, referred to as “GUI screen”) at the occurrence of a problem is stored (screen capturing) and then is attached to document data in some cases.

When the problem report is generated in written form, however, it is sometimes difficult to represent the place where the problem occurs. For a problem related to GUI, the GUI screen at the occurrence of the problem is attached in some cases as described above. In such a case, however, a viewer of the problem report needs to make allowance for the content of the document by contrasting the content of the document with the GUI screen attached thereto. Therefore, it is often difficult to find the place where the problem occurs. Moreover, the work of storing image data of the GUI screen and attaching the image data to document data every time the problem is found in a test requires labor hours inefficiently. Furthermore, it has been difficult from the problem report in written form for the viewer of the problem report to intuitively grasp how many problems are reported in which part of the software.

In view of these problems, it is an object of the present invention to generate a problem report which is easy to generate, from which the source of a problem is easily identified, and by which the viewer of the problem report is able to intuitively and easily grasp the source of the problem.

In order to achieve the above object, the present invention is implemented as an apparatus as described below. This apparatus, which executes and tests software, includes: an execution unit which executes the software to be tested; an interface screen control unit which causes a display device to display an interface screen by the software to be tested and receives a user's input operation using the interface screen; and a problem report management unit which manages information on a problem which has occurred in the test of the software. The problem report management unit includes: a selection operation receiving unit which receives a selection of a component part of the interface screen; an input receiving unit which receives a user's input of information; a report generating unit which generates report information on the component part, based on information on the component part related to the selection received by the selection operation receiving unit and information received by the input receiving unit; and a notification display unit which performs notification display to give notice that there is a component part for which report information has been generated, in the case where the component part related to the selection received by the selection operation receiving unit includes the component part for which the report information has been generated by the report generating unit.

More preferably, the notification display unit performs a display indicating that the report information has been generated for the component part for which the report information has been generated. Still preferably, the problem report management unit further includes image data acquisition means which acquires image data of the interface screen in the case of receiving a selection operation using the selection operation receiving unit and the report generating unit generates the report information including information on the image data acquired by the image data acquisition means. Further preferably, the problem report management unit further includes a problem report output unit which receives a selection of the component part for which the report information has been generated and displays the report information on the selected component part on the display device.

Furthermore, the present invention is also achieved as a program which controls a computer to implement the functions of the aforementioned apparatus. This program can be provided by being stored in a magnetic disk, an optical disk, a semiconductor memory, or any other recording mediums for distribution or by being delivered over a network.

According to the present invention, it is possible to generate a problem report which is easy to generate, from which the source of a problem is easily identified, and by which the viewer of the problem report is able to intuitively and easily grasp the source of the problem.

Thus, in one embodiment, a problem report management unit 220, which runs and tests an application to manage information on a problem which has occurred, includes: a selection operation receiving unit 221 which receives a selection of a component part of a GUI screen; an input receiving unit 223 which receives a user's input of information; a problem report generating unit 224 which generates report information on the component part, based on information on the component part related to the selection received by the selection operation receiving unit 221 and information received by the input receiving unit 223; and a notification display unit 225 which performs notification display to give notice that there is a component part for which report information has been generated, in the case where the component part related to the selection received by the selection operation receiving unit 221 includes the component part for which the report information has been generated by the problem report generating unit 224.

What is claimed is:

1. An apparatus that executes and tests software, the apparatus comprising:
an execution hardware unit that executes software to be tested;
an interface screen control hardware unit that causes a display device to display an interface screen by the software to be tested and receives a user's input operation using the interface screen; and
a problem report management hardware unit that manages information on a problem that has occurred during a test of the software, wherein the problem report management unit includes:
a selection operation receiving hardware unit that receives a selection of a component part of the interface screen;
an input receiving hardware unit that receives a user's input of information;
a report generating hardware unit that generates report information on the component part, based on information on the component part related to the selection received by the selection operation receiving unit and information received by the input receiving unit; and
a notification display hardware unit that performs notification display to give notice that there is a component part for which report information has been generated, in response to the component part related to the selection received by the selection operation receiving unit including the component part for which the report information has been generated by the report generating unit.

2. The apparatus according to claim 1, wherein the notification display hardware unit performs a display indicating that the report information has been generated for the component part for which the report information has been generated.

3. The apparatus according to claim 1, further comprising:
image data acquisition means that acquires image data of the interface screen in response to receiving a selection operation using the selection operation receiving hardware unit.

4. The apparatus according to claim 1, further comprising:
an input receiving hardware unit that receives a user's input of information.

5. The apparatus according to claim 1, further comprising:
a problem report output hardware unit that receives a selection of the component part for which the report information has been generated and displays the report information on the selected component part on a display device.

6. An apparatus that executes and tests software, the apparatus comprising:
an execution hardware unit that executes software to be tested;
an interface screen control hardware unit that causes a display device to display an interface screen by the software to be tested and receives a user's input operation using the interface screen; and
a problem report management hardware unit that manages information on a problem that has occurred during a test of the software, wherein the problem report management hardware unit includes:
a selection operation receiving hardware unit that receives a selection of a component part of the interface screen;
an input receiving hardware unit that receives a user's input of information; and
a report generating hardware unit that generates report information on the component part, based on information on the component part related to the selection received by the selection operation receiving hardware unit and information received by the input receiving hardware unit.

7. The apparatus according to claim 6, wherein:
the problem report management hardware unit further includes image data acquisition means that acquires image data of the interface screen in response to receiving a selection operation using the selection operation receiving hardware unit; and
the report generating hardware unit generates the report information including information on the image data acquired by the image data acquisition means.

8. An apparatus that executes and tests software, the apparatus comprising:
an execution hardware unit that executes software to be tested;
an interface screen control hardware unit that causes a display device to display an interface screen by the software to be tested and receives a user's input operation using the interface screen; and
a problem report management hardware unit that manages information on a problem that has occurred during a test of the software, wherein the problem report management hardware unit includes:
a selection operation receiving hardware unit that receives a selection of a component part of the interface screen;
an acquisition hardware unit that acquires report information generated with respect to the component part of the interface screen; and
a notification display hardware unit that performs notification display to give notice to a selection part, which is the component part related to the selection received by the selection operation receiving hardware unit, that there is a component part for which report information has been generated, in a case in which the selection part includes the component part for which the report information has been generated.

9. The apparatus according to claim 8, wherein the notification display hardware unit performs a display indicating that the report information has been generated for the component part for which the report information has been generated.

10. The apparatus according to claim 8, wherein the problem report management hardware unit further includes a problem report output hardware unit that receives a selection of the component part for which the report information has been generated and displays the report information on the selected component part on the display device.
